(19) United States
(12) Patent Application Publication
(10) Pub. No.: US 2011/0044212 A1
(43) Pub. Date: Feb. 24, 2011

(54) INFORMATION PROCESSING APPARATUS, CONFERENCE SYSTEM AND INFORMATION PROCESSING METHOD

(75) Inventor: Daisuke TANI, Osaka-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 12/859,885

(22) Filed: Aug. 20, 2010

(30) Foreign Application Priority Data
Aug. 21, 2009 (JP) 2009-192432

(51) Int. Cl. G06K 9/46; H04L 12/16

(52) U.S. Cl. 370/260; 382/190

(57) ABSTRACT

In a terminal apparatus used by a speaker, sounds are inputted via a microphone to perform sound recognition processing and morphological analysis, a character string obtained as a result of the analysis is extracted using a predetermined condition, and the extracted character string is transmitted to other terminal apparatuses via a conference server apparatus. On each of the other terminal apparatuses, the extracted character string, which has been received, is displayed in a selectable manner. The selected character string is displayed in a superimposed manner on an image of shared document data. The character string converted from sounds uttered by the speaker at a conference is freely placed on the shared image, thereby effectively aiding a conference participant to make a note at the conference.

### CROSS-REFERENCE TO RELATED APPLICATIONS

This Nonprovisional application claims priority under 35 U.S.C.§119(a) on Patent Application No. 2009-192432 filed in Japan on Aug. 21, 2009, the entire contents of which are hereby incorporated by reference.

### BACKGROUND

1. Technical Field

The present invention relates to a conference system capable of implementing a conference among users even when they are at remote sites by sharing sound, video and image among a plurality of information processing apparatuses connected via a network. In particular, the present invention relates to an information processing apparatus, a conference system including a plurality of the information processing apparatuses, and an information processing method, which are capable of effectively aiding a user to make a note at a conference.

2. Description of Related Art

The advancement of communication technology, image processing technology, etc. has implemented a videoconference capable of allowing conference participants to participate in a conference via a network even when they are at remote sites by using computers. In a videoconference, conference participants are allowed to browse common document data and the like using a plurality of terminal apparatuses, and an editing/adding process performed on document data can also be shared.

During a conference, respective conference participants usually make notes of discussions conducted at the conference. A person selected as a minutes recorder takes notes on statements made by all speakers. In this case, statements are made by a plurality of people, and the conference is held while reference is made to materials and or like which are commonly browsed; therefore, it might be very burdensome to make notes because, for example, a conference participant might fail to hear a statement or might not be able to follow the reference made to the materials.

Japanese Patent Application Laid-Open No. 2002-290939 relates to a terminal apparatus used in an electronic conference system, and discloses an invention in which important data is accumulated in advance, a statement made by a conference participant or ranking of a conference participant is compared with the accumulated important data, and in accordance with the statement or ranking, a display mode is changed when information of the statement or conference participant is displayed on a shared window on which information sharable among conference participants is displayed. For example, when the statement is related to the important data, the statement is displayed in a highlighted manner by boldfacing of text, change of text color, addition of an underline, and addition of a mark, for example.

Furthermore, Japanese Patent Application Laid-Open No. 2008-209717 discloses an invention in which input sound is morphologically analyzed and obtained as a character string by utilizing a sound recognition technique, and a plurality of candidates are outputted to a display section so as to be selectable. A sound input made by a speaker can be converted into a character string and used for a note by applying the foregoing invention to an electronic conference system.

### SUMMARY

In the invention disclosed in Japanese Patent Application Laid-Open No. 2002-290939, a statement (which is not sound) or the like related to important information is displayed in a highlighted manner on a shared screen, which facilitates grasping of a key factor for a note, thus making it possible to aid a conference participant to make a note at a conference to some extent. However, even though the statement or the like is displayed in a highlighted manner on the shared screen, inputted sound or the like will not be kept as a note.

In the invention disclosed in Japanese Patent Application Laid-Open No. 2008-209717, sounds uttered by a speaker are converted into a character string, thus making it possible to aid a conference participant to make a note at a conference to some extent. However, no consideration is given to a case where sound contents converted into a character string are provided by making reference to other information, e.g., contents of an image.

In an electronic conference system implemented via a network, a statement of each conference participant is made with reference to, for example, image or video of shared materials. Accordingly, it is preferable that in addition to conversion of a statement into a character string, an effective note, by which visual grasping of a relationship of the character string with a referenced image is enabled, can be made with a reduced operational burden.

The present invention has been made in view of the above-described circumstances, and its object is to provide an information processing apparatus, a conference system including a plurality of the information processing apparatuses, and an information processing method, which are, for example, capable of allowing a conference participant to freely place a character string, converted from sounds uttered by a speaker at a conference, over a shared image on the information processing apparatus used by himself or herself, and thus capable of effectively aiding the conference participant to make a note at the conference.

A first aspect of the present invention provides an information processing apparatus for receiving image information via communication means, and for displaying, on a display section, an image provided based on the received image information, the information processing apparatus including: means for acquiring sound data related to the image information, and for converting the sound data into a character string; means for performing morphological analysis on the converted character string; means for extracting a character string that satisfies a condition set in advance, the character string being extracted from character strings each including a single or a plurality of morphemes obtained as a result of the analysis performed by the means for performing morphological analysis; means for displaying, on the display section, the character string extracted by the means for extracting a character string; selection means for receiving selection of anyone or a plurality of character strings included in the displayed character strings; and means for displaying the selected character string in a superimposed manner at any position on the image provided based on the image information.

In the present invention, sound data related to image information received from an external apparatus (server apparatus) is acquired and converted into a character string, and morphological analysis is performed on the converted character string. A character string, which satisfies a condition set in advance, is extracted from the character strings obtained as a result of the morphological analysis, and the extracted character string is displayed on the display section together with the image provided based on the received image information. Note that the extracted character string may be transmitted to other apparatus (in other words, the extracted character string may be transmitted to the server apparatus, or may be transmitted to other information processing apparatuses via the server apparatus). Then, selection of a single or a plurality of character strings included in the extracted character strings is received. The selected single or plurality of character strings is/are displayed on the image provided based on the image information.

Thus, of the character strings converted from sounds related to the image, the character string that satisfies the set condition is displayed on the display section so as to be selectable, and can be displayed on the image. The condition is allowed to be set to optionally, thus extracting a character string that reflects the intent of a user.

Note that processing such as the conversion from sound data into a character string, morphological analysis and character string extraction, and processing such as displaying of the extracted character string on the image may be carried out in the same information processing apparatus, or may be carried out separately in the different apparatuses. The extracted character strings may be transmitted from the server apparatus to the information processing apparatuses used by a plurality of users, and the character strings optionally selected by the users may be displayed on the respective information processing apparatuses.

A second aspect of the present invention provides an information processing apparatus for receiving image information via communication means, and for displaying, on a display section, an image provided based on the received image information, the information processing apparatus including: means for receiving a plurality of character strings provided based on sound data related to the image information, and for displaying a plurality of the received character strings on the display section; selection means for receiving selection of any one or a plurality of character strings included in a plurality of the displayed character strings; and means for displaying the selected character string in a superimposed manner at any position on the image provided based on the image information.

In the present invention, the image provided based on the image information received from the external apparatus (server apparatus) is displayed on the display section; furthermore, a plurality of character strings, converted from sound data and extracted by the external apparatus (i.e., the server apparatus or the other information processing apparatus), are received and displayed together with the image, and selection of a single or a plurality of character strings is received. The selected single or plurality of character strings is/are displayed on the image provided based on the image information received from the external apparatus.

When a source of conversion for the character strings received from the external apparatus is sound data related to the image information transmitted from the external apparatus, the character string related to the image provided based on the image information is displayed and is selectable by the user; moreover, the selected character string is displayed on the image.

Thus, sound contents related to the image can be visually grasped together with the image. Furthermore, the character string converted from sounds is selectable even when a note is not handwritten.

A third aspect of the present invention provides the information processing apparatus including means for receiving a change in the position of the selected character string, received by the selection means, on the image provided based on the image information.

In the present invention, when the selected single or plurality of character strings is/are drawn on the image provided based on the received image information, the selection of the position(s) of the character string(s) on this image can also be received freely. For example, a document includes a plurality of images or characters, and when this document is displayed, the present invention enables selection of position(s) of character string(s) on the image so as to allow the user to visually grasp to which image or character the character string(s) is/are related, i.e., the relation between the character string(s) and the image provided based on the image information.

A fourth aspect of the present invention provides the information processing apparatus further including means for receiving an edit made on the selected character string received by the selection means.

In the present invention, an edit made on the selected single or plurality of character strings is received. Thus, addition or deletion, for example, of the character string(s) is enabled.

A fifth aspect of the present invention provides the information processing apparatus further including means for receiving a change in format of the selected character string received by the selection means.

In the present invention, a change in format of the selected single or plurality of character strings is received. Thus, a change in character size of the character string, a change in font, a change in character color, etc. are enabled.

A sixth aspect of the present invention provides the information processing apparatus including: means for storing an optional plurality of terms in advance; means for extracting, from the plurality of terms, a term related to the character string displayed on the display section; and means for displaying the extracted term on the display section.

In the present invention, an optional plurality of terms are stored in advance, a term related to one presented in the character string displayed on the display section is extracted, and the extracted term is further displayed on the display section. Thus, after morphological analysis of sound data, selection of terms, including a term related to the extracted character string or a term related to the already selected character string, can be received as character string candidates to be displayed. Terms other than those included in sound data itself can also be utilized for a note.

A seventh aspect of the present invention provides the information processing apparatus, wherein the condition set in advance is set using a type of part of speech or a combination of types of parts of speech.

In the present invention, the condition set in advance for character string extraction is set using a type of part of speech such as a noun, a verb or an adjective, or a combination of types of these parts of speech. Thus, terms such as a preposition and a conjunctive can be excluded from character strings converted from sound data, thereby making it possible to narrow down targets to be selected. Further, only a particular noun is set as the condition, for example, thereby also allowing only a character string, which satisfies the particular condition, to be extracted.

An eighth aspect of the present invention provides the information processing apparatus including: means for receiving input of an optional character string or image; and means for receiving a change in the position of the inputted character string or image, wherein the inputted character string or image is displayed based on the resulting position.

In the present invention, in addition to a character string selected from the extracted character strings displayed on the display section, or the character string on which an edit has been made or the format of which has been changed, an optional character string or image inputted by the user is also displayed. In addition to the selected character string, optional information can also be displayed.

A ninth aspect of the present invention provides a conference system including: a server apparatus for storing image information; and a plurality of information processing apparatuses each capable of communicating with the server apparatus and including a display section, wherein the plurality of information processing apparatuses each receive the image information from the server apparatus to display, on the display section, an image provided based on the received image information, and allow a common image to be displayed on the plurality of information processing apparatuses so that information is shared among the plurality of information processing apparatuses, thereby implementing a conference,

wherein the server apparatus or at least one of the plurality of information processing apparatuses includes: means for inputting of a sound; and conversion means for converting the sound, inputted by the means for inputting of a sound, into a character string, wherein the server apparatus or any of the plurality of information processing apparatuses includes: means for performing morphological analysis on the character string that has been converted by the conversion means; extraction means for extracting a character string that satisfies a condition set in advance, the character string being extracted from character strings each including a single or a plurality of morphemes obtained as a result of the analysis performed by the means for performing morphological analysis; and means for transmitting, to the server apparatus, the character string extracted by the extraction means, wherein the server apparatus includes means for transmitting, to any one or a plurality of the information processing apparatuses, the character string extracted by the extraction means, and wherein the information processing apparatus includes: means for displaying, on the display section, the character string received from the server apparatus; means for receiving selection of any one or a plurality of character strings included in the displayed character strings; and means for displaying the selected character string in a superimposed manner at any position on the image provided based on the image information.

A tenth aspect of the present invention provides an information processing method for using an information processing apparatus, including communication means and a display section, to display, on the display section, an image provided based on received image information, the information processing method including steps of: acquiring sound data related to the image information and converting the sound data into a character string; performing morphological analysis on the converted character string; extracting a character string that satisfies a condition set in advance, the character string being extracted from character strings each including a single or a plurality of morphemes obtained as a result of the analysis; displaying the extracted character string on the display section; receiving selection of any one or a plurality of character strings included in the displayed character strings; and displaying the selected character string in a superimposed manner at any position on the image provided based on the image information.

An eleventh aspect of the present invention provides an information processing method for using a system including: a server apparatus for storing image information; and a plurality of information processing apparatuses each capable of communicating with the server apparatus and including a display section, in which the plurality of information processing apparatuses each receive the image information from the server apparatus to display, on the display section, an image provided based on the received image information, and allow a common image to be displayed on the plurality of information processing apparatuses so that information is shared among the plurality of information processing apparatuses, the information processing method including steps of: allowing at least one apparatus of the server apparatus and the plurality of information processing apparatuses to input a sound associated with an image that is being displayed; allowing at least one apparatus of the server apparatus and the plurality of information processing apparatuses to convert the inputted sound into a character string; allowing the server apparatus or any of the plurality of information processing apparatuses to perform morphological analysis on the character string that has been converted by the at least one apparatus; allowing the server apparatus or any of the plurality of information processing apparatuses to extract a character string that satisfies a condition set in advance, the character string being extracted from character strings each including a single or a plurality of morphemes obtained as a result of the morphological analysis; allowing the server apparatus or any of the plurality of information processing apparatuses to transmit the extracted character string to the server apparatus, or to store the extracted character string in the server apparatus or information processing apparatus itself; allowing the server apparatus to transmit the extracted character string to any one or a plurality of the information processing apparatuses; allowing the information to processing apparatus, which has received the extracted character string, to display the received character string on the display section; allowing the information processing apparatus, which has received the extracted character string, to receive selection of any one or a plurality of character strings included in the displayed character strings; and allowing the information processing apparatus, which has received the extracted character string, to display the selected character string in a superimposed manner at any position on the image provided based on the image information.

In the present invention, sound contents related to an image to be displayed can be visually grasped together with the image in the information processing apparatus. A user is allowed to select a character string converted from sounds without taking a note by handwriting. Both of an operation for listening to a voice of an optional speaker and an operation for taking a note by handwriting require considerable efforts; however, in the present invention, together with an image to be displayed, a character string candidate indicative of sound contents related to this image is displayed so as to be selectable, thus reducing the burden of the handwriting operation. The selected character string can be displayed on an image provided based on received image information.

Although the information processing apparatus according to the present invention is utilized in a computer-based conference system, the need for a burdensome operation such as an operation for handwriting a note on a paper medium is eliminated, thereby making it possible to aid the user to make a visually effective note. With the use of the information processing apparatus of the present invention, the user can make an effective note without burden.

Further, in the present invention, of character strings converted from sounds related to an image to be displayed, a character string, which reflects the user's intent, is allowed to be extracted using an optionally set condition so that the extracted character string is selectable. The user can make an efficient and effective note without burden.

Moreover, in the present invention, a character string, extracted based on sounds related to an image to be displayed, can be placed so as to allow the user to visually grasp to which portion of the image (including a plurality of images or characters) the character string is related. The present invention not only can aid the user to make a note by simply converting sounds into a character string, but also allow the user to make an effective note that enables visual grasping of contents of sounds (conference discussions). The present invention can also allow the user to visually grasp, for example, which image or character included in an image displayed in a shared manner is indicated by a sound such as a directive.

Furthermore, in the present invention, an edit can be further made on a character string selected from displayed character strings. Accordingly, an error or the like caused at the time of conversion from sound data into a character string can also be corrected, and information that does not exist as sounds can be provided as supplement, addition, etc. The application of the present invention to a conference system can reduce the burden of note making, and can effectively aid note making at a conference.

Besides, in the present invention, a character string selected from displayed character strings can be changed in format. Accordingly, as for important information, a change in character size of the character string, a change in font, a change in character color, etc. are made, thereby making it possible to write a note displayed in a highlighted manner; thus, the application of the present invention to a conference system can reduce the burden of note making, and can effectively aid note making at a conference.

Further, in the present invention, a related term other than terms included in sound data that is a source of conversion for a character string can also be utilized for a note, and the user is allowed to perform a note making operation without burden by flexibly reflecting his or her intent.

Furthermore, in the present invention, character strings to be extracted, i.e., character strings to be selected as displayed character strings, can be narrowed down by reflecting the user's intent so that only a character string such as a noun, which satisfies a particular condition, is extracted. Thus, the user is allowed to perform a note making operation without burden by reflecting his or her intent.

Moreover, in the present invention, the user can also make a correction of a note such as a correction of false recognition as appropriate while receiving the aid of a character string converted from sound data, and furthermore, the user can perform an operation for making an effective note, including an opinion of the user himself or herself or addition such as highlighted display that uses a box or an underline, for example, without burden.

The above and further objects and features of the invention will more fully be apparent from the following detailed description with accompanying drawings.

### BRIEF DESCRIPTION OF THE SEVERAL VIEWS OF THE DRAWINGS

FIG. 1 is a diagrammatic representation schematically illustrating a configuration of a conference system according to Embodiment 1;

FIG. 2 is a block diagram illustrating an internal configuration of a terminal apparatus included in the conference system according to Embodiment 1;

FIG. 3 is a block diagram illustrating an internal configuration of a conference server apparatus included in the conference system according to Embodiment 1;

FIG. 4 is an explanatory diagram schematically illustrating how document data is shared among terminal apparatuses of the conference system according to Embodiment 1;

FIG. 5 is an explanatory diagram illustrating an example of a main screen of a conference terminal application, displayed on a display of a terminal apparatus used by a conference participant;

FIG. 6 is a flow chart illustrating an example of a procedure of processing performed by the terminal apparatuses and conference server apparatus included in the conference system according to Embodiment 1;

FIG. 7 is a flow chart illustrating processing for extracting a character string, which satisfies a condition, from character strings obtained by morphological analysis executed by a control section of the terminal apparatus included in the conference system according to Embodiment 1;

FIG. 8 is an explanatory diagram schematically illustrating a specific example of the processing procedure illustrated in FIGS. 6 and 7;

FIG. 9 is an explanatory diagram schematically illustrating a specific example of the processing procedure illustrated in FIGS. 6 and 7;

FIG. 10 is a block diagram illustrating an internal configuration of a terminal apparatus included in a conference system according to Embodiment 2;

FIG. 11 is a block diagram illustrating an internal configuration of a conference server apparatus included in the conference system according to Embodiment 2; and

FIG. 12 is a flow chart illustrating an example of a procedure of processing performed by the terminal apparatuses and conference server apparatus included in the conference system according to Embodiment 2.

### DETAILED DESCRIPTION

Hereinafter, the present invention will be specifically described with reference to the drawings illustrating embodiments thereof.

Note that the following embodiments will be described using, as an example, a conference system in which an information processing apparatus of the present invention is used as a terminal apparatus, and sound, video and image are shared with the use of a plurality of the terminal apparatuses.

### Embodiment 1

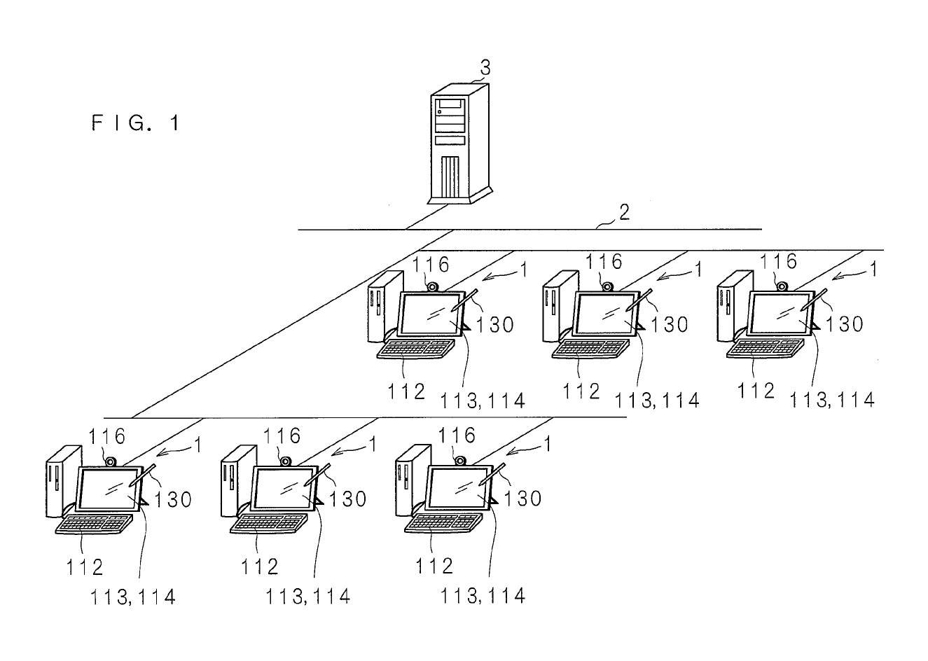

FIG. 1 is a diagrammatic representation schematically illustrating a configuration of a conference system according to Embodiment 1. The conference system according to Embodiment 1 is configured to include: terminal apparatuses 1, 1, . . . used by conference participants; a network 2 to which the terminal apparatuses 1, 1, . . . are connected; and a conference server apparatus 3 for allowing sound, video and image to be shared among the terminal apparatuses 1, 1, . . . .

The network 2, to which the terminal apparatuses 1, 1, . . . and the conference server apparatus 3 are connected, may be an in-house LAN of a company organization in which a conference is held, or may be a public communication network such as the Internet. The terminal apparatuses 1, 1, . . . are authorized to connect with the conference server apparatus 3, and the authorized terminal apparatuses 1, 1, . . . receive/transmit information such as shared sound, video and image from/to the conference server apparatus 3 and output the received sound, video and image, thus allowing the sound, video and image to be shared with the other terminal apparatuses 1, . . . to implement a conference via the network.

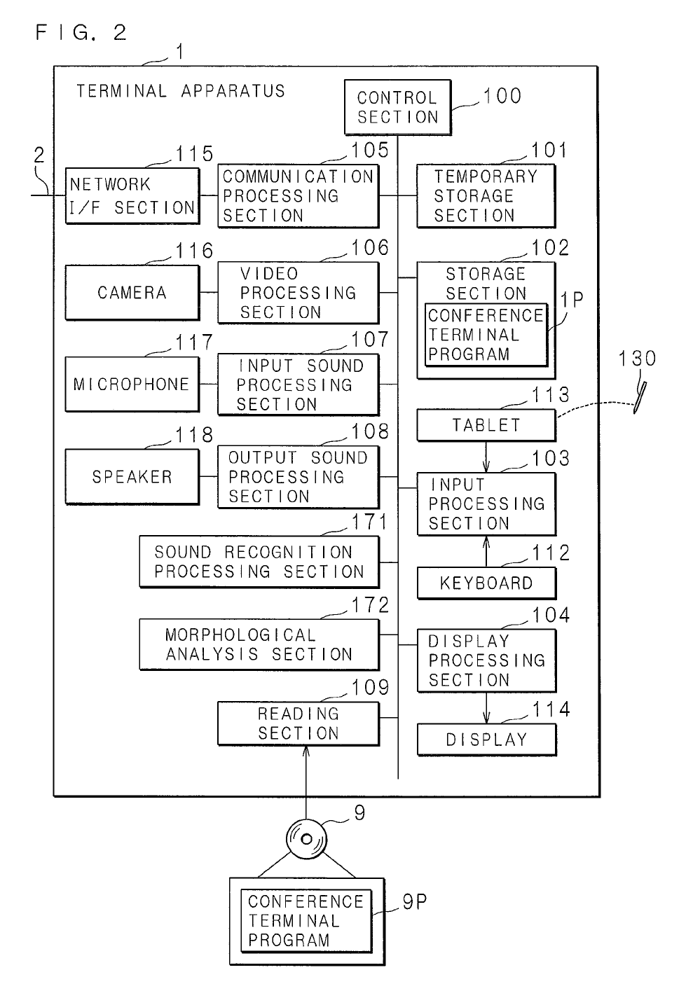

FIG. 2 is a block diagram illustrating an internal configuration of the terminal apparatus 1 included in the conference system according to Embodiment 1.

For the terminal apparatus 1 included in the conference system, a personal computer equipped with a touch panel or a terminal intended exclusively for use in the conference system is used. The terminal apparatus 1 includes: a control section 100; a temporary storage section 101; a storage section 102; an input processing section 103; a display processing section 104; a communication processing section 105; a video processing section 106; an input sound processing section 107; an output sound processing section 108; a reading section 109; a sound recognition processing section 171; and a morphological analysis section 172. The terminal apparatus 1 further includes a keyboard 112, a tablet 113, a display 114, a network I/F section 115, a camera 116, a microphone 117, and a speaker 118, which may be contained in the terminal apparatus 1 or may be externally connected to the terminal apparatus 1.

For the control section 100, a CPU (Central Processing Unit) is used. The control section 100 loads a conference terminal program 1P, stored in the storage section 102, into the temporary storage section 101, and executes the loaded conference terminal program 1P, thereby operating, as the information processing apparatus according to the present invention, the touch-panel-equipped personal computer or the terminal intended exclusively for use in the conference system.

For the temporary storage section 101, a RAM such as an SRAM (Static Random Access Memory) or a DRAM (Dynamic Random Access Memory) is used. The temporary storage section 101 stores the conference terminal program 1P loaded as mentioned above, and further stores information generated by processing performed by the control section 100.

For the storage section 102, an external device such as a hard disk or an SSD (Solid State Drive) is used. The storage section 102 stores the conference terminal program 1P. In addition, the storage section 102 may naturally store any other application software program for the terminal apparatus 1.

An input user interface such as an unillustrated mouse or the keyboard 112 is connected to the input processing section 103. In Embodiment 1, the terminal apparatus 1 contains, on the display 114, the tablet 113 for receiving an input made by a pen 130. The tablet 113 on the display 114 is also connected to the input processing section 103. The input processing section 103 receives information such as button pressing information inputted by an operation performed on the terminal apparatus 1 by a user (conference participant) and/or coordinate information indicative of a position on a screen, and notifies the control section 100 of the received information.

The touch-panel-type display 114, for which a liquid crystal display or the like is used, is connected to the display processing section 104. The control section 100 outputs a conference terminal application screen to the display 114 via the display processing section 104, and allows the display 114 to display an image to be shared in the application screen.

For the communication processing section 105, a network card or the like is used. The communication processing section 105 realizes communication performed via the network 2 for the terminal apparatus 1. More specifically, the communication processing section 105 is connected to the network 2 and to the network I/F section 115, divides information, received/transmitted via the network 2, into packets, and reads information from packets, for example. It should be noted that in order to implement the conference system according to Embodiment 1, a protocol such as H.323, SIP (Session Initiation Protocol) or HTTP (Hypertext Transfer Protocol) may be used as a communication protocol for receiving/transmitting an image and a sound by the communication processing section 105. However, the communication protocol to be used is not limited to these protocols.

The video processing section 106 is connected to the camera 116 included in the terminal apparatus 1, controls an operation of the camera 116, and acquires data of video (image) taken by the camera 116. The video processing section 106 may include an encoder, and may perform a process for converting the video, taken by the camera 116, into data conforming to a video standard such as H.264, MPEG (Moving Picture Experts Group).

The input sound processing section 107 is connected to the microphone 117 included in the terminal apparatus 1, and has an A/D conversion function that samples sounds collected by the microphone 117, converts the sounds into digital sound data, and outputs the digital sound data to the control section 100. The input sound processing section 107 may contain an echo canceller.

The output sound processing section 108 is connected to the speaker 118 included in the terminal apparatus 1. The output sound processing section 108 has a D/A conversion function so as to allow sounds to be outputted from the speaker 118 when sound data is supplied from the control section 100.

The reading section 109 is capable of reading information from a recording medium 9 such as a CD-ROM, a DVD, a Blu-ray disc or a flexible disk. The control section 100 stores data, recorded on the recording medium 9, in the temporary storage section 101 or in the storage section 102 via the reading section 109. The recording medium 9 records a conference terminal program 9P for operating a computer as the information processing apparatus according to the present invention. The conference terminal program 1P recorded in the storage section 102 may be a copy of the conference terminal program 9P read from the recording medium 9 by the reading section 109.

The sound recognition processing section 171 includes a dictionary that defines the correspondence between sounds and character strings, and performs, upon supply of sound data, sound recognition processing for converting the sound data into a character string to output the resulting character string. The control section 100 supplies digital sound data, obtained by the input sound processing section 107, to the sound recognition processing section 171 in predetermined units, and acquires the character string outputted from the sound recognition processing section 171.

The morphological analysis section 172 performs morphological analysis when a character string is supplied thereto, divides the supplied character string into morphemes to output the resulting morphemes, and outputs information or the like indicative of how many morphemes are included in the character string and the part of speech of each morpheme. The control section 100 supplies, to the morphological analysis section 172, the character string acquired from the sound recognition processing section 171, thereby allowing the sound data, obtained by the input sound processing section 107, to be converted into a sentence. For example, when a character string such as “the value is very important.” is acquired by the sound recognition processing section 171, the control section 100 can obtain, via the morphological analysis section 172, a character string that is divided into morphemes as follows: “the (article)/value (noun)/is (verb)/very (adverb)/important (adjective)/. (period)”.

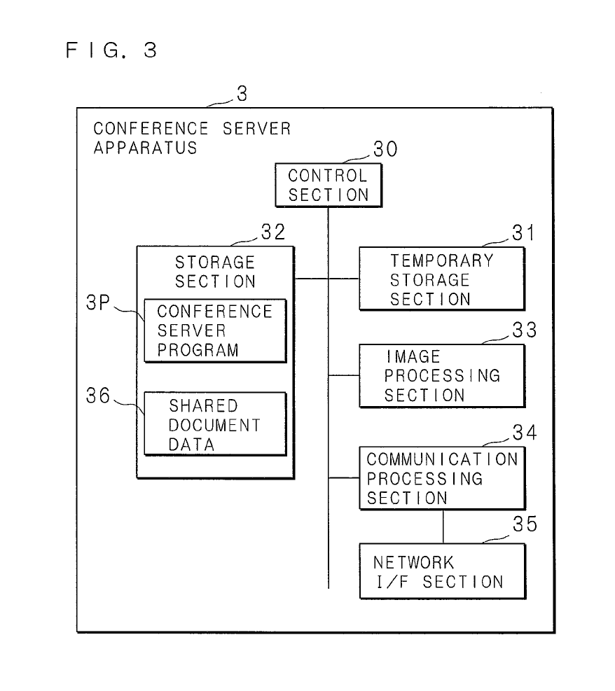

FIG. 3 is a block diagram illustrating an internal configuration of the conference server apparatus 3 included in the conference system according to Embodiment 1.

For the conference server apparatus 3, a server computer is used. The conference server apparatus 3 includes: a control section 30; a temporary storage section 31; a storage section 32; an image processing section 33; and a communication processing section 34, and further contains a network I/F section 35.

For the control section 30, a CPU is used. The control section 30 loads a conference server program 3P, stored in the storage section 32, into the temporary storage section 31, and executes the loaded conference server program 3P, thereby operating the sever computer as the conference server apparatus 3 according to Embodiment 1.

For the temporary storage section 31, a RAM such as an SRAM or a DRAM is used. The temporary storage section 31 stores the conference server program 3P loaded as mentioned above, and temporarily stores after-mentioned image information or the like by processing performed by the control section 30.

For the storage section 32, an external storage device such as a hard disk or SSD is used. The storage section 32 stores the foregoing conference server program 3P. The storage section 32 further stores authentication data for authenticating the terminal apparatuses 1, 1, . . . used by the conference participants. Moreover, in order to allow shared materials to be displayed on the respective terminal apparatuses 1, 1, . . . in the conference system, the storage section 32 of the conference server apparatus 3 stores a plurality of pieces of document data as shared document data 36. The document data includes text data, photograph data and graphic data, and the format thereof, for example, may be any format.

The image processing section 33 creates an image in accordance with an instruction provided from the control section 30. Specifically, of the shared document data 36 stored in the storage section 32, the document data to be displayed on the respective terminal apparatuses 1, 1, . . . is received by the image processing section 33, and the image processing section 33 converts this document data into an image and outputs the resulting image.

For the communication processing section 34, a network card or the like is used. The communication processing section 34 realizes communication performed via the network 2 for the conference server apparatus 3. More specifically, the communication processing section 34 is connected to the network 2 and to the network I/F section 35, divides information, received/transmitted via the network 2, into packets, and reads information from packets, for example. It should be noted that in order to implement the conference system according to Embodiment 1, a protocol such as H.323, SIP or HTTP may be used as a communication protocol for receiving/transmitting an image and a sound by the communication processing section 34. However, the communication protocol to be used is not limited to these protocols.

The conference participant, participating in an electronic conference with the use of the conference system according to Embodiment 1 configured as described above, utilizes the terminal apparatus 1, and starts up a conference terminal application using the keyboard 112 or the tablet 113 (i.e., the pen 130). Upon start up of the conference terminal application, an authentication information input screen is displayed on the display 114. The conference participant inputs authentication information such as a user ID and a password to the input screen. The terminal apparatus 1 receives the input of the authentication information by the input processing section 103, and notifies the control section 100 of the authentication information. The control section 100 transmits the received authentication information to the conference server apparatus 3 by the communication processing section 105, and receives an authentication result therefrom. In this case, together with the authentication information, information on an IP address allocated to the terminal apparatus 1 is transmitted to the conference server apparatus 3. Thus, the conference server apparatus 3 can identify each of the terminal apparatuses 1, 1, . . . based on its IP address thereafter.

When the conference participant utilizing the terminal apparatus 1 is an authorized person, the terminal apparatus 1 displays a conference terminal application screen, thereby allowing the conference participant to utilize the terminal apparatus 1 as the conference terminal. In this case, when an authorization result indicates that the conference participant is unauthorized, i.e., when the conference participant is a person uninvited to the conference, the terminal apparatus 1 may display, on the display 114, a message saying that the conference participant is unauthorized, for example.

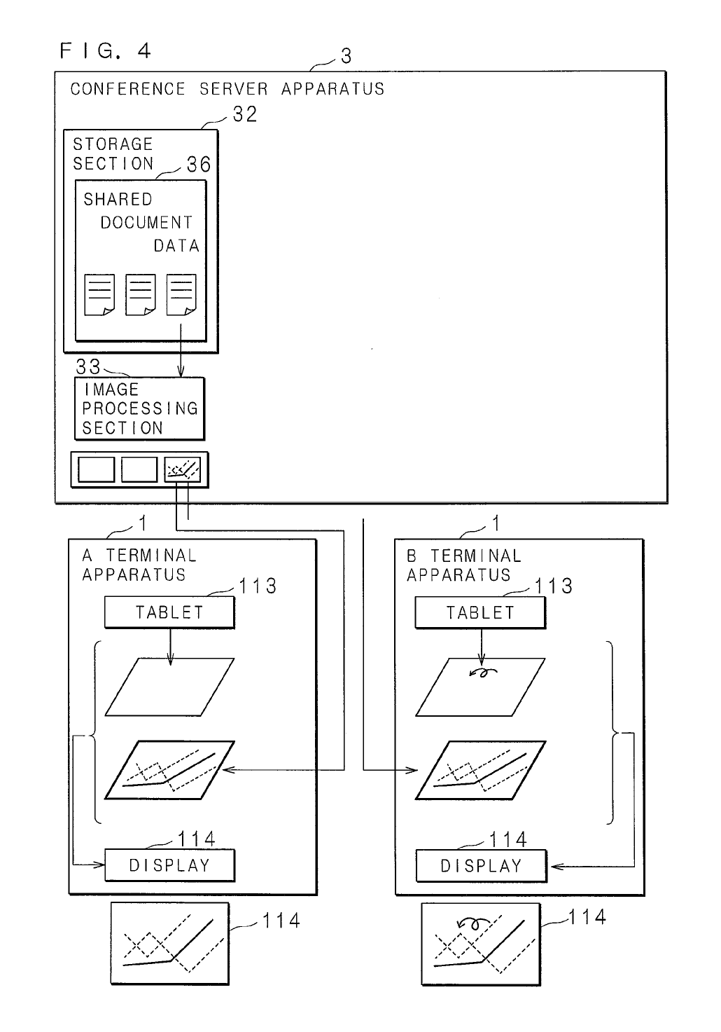

Hereinafter, how the document data is shared among the terminal apparatuses 1, 1, . . . to implement the conference will be described using a schematic diagram. FIG. 4 is an explanatory diagram schematically illustrating how the document data is shared among the terminal apparatuses of the conference system according to Embodiment 1.

The storage section 32 of the conference server apparatus 3 stores the shared document data 36. Of all pieces of the shared document data 36, the shared document data 36 used in the conference is converted into images (imagery) on a page-by-page basis by the image processing section 33. The document data converted into images on a page-by-page basis by the image processing section 33 is received by the terminal apparatuses 1, 1, . . . via the network 2. Note that in order to make a distinction between two of the terminal apparatuses below, one of the terminal apparatuses will be referred to as an “A terminal apparatus 1”, and the other terminal apparatus will be referred to as a “B terminal apparatus 1”.

Each of the A terminal apparatus 1 and the B terminal apparatus 1 receives, from the conference server apparatus 3, the images of the shared document data converted on a page-by-page basis, and outputs the received images from the display processing section 104 so as to display the images on the display 114. In this case, the display processing section 104 draws the image of each page of the shared document data so that the image belongs to a lowermost layer in a displayed screen.

Further, the A terminal apparatus 1 and the B terminal apparatus 1 are each capable of writing a note on the tablet 113 by the pen 130. The control section 100 creates an image in accordance with an input made by the pen 130 via the input processing section 103. The image created by each of the A terminal apparatus 1 and the B terminal apparatus 1 is drawn so that the image belongs to an upper layer in the displayed screen.

Thus, as illustrated in a lowermost part of FIG. 4, in each of the A terminal apparatus 1 and the B terminal apparatus 1, the image written on the tablet 113 of the A terminal apparatus 1 or B terminal apparatus 1 itself is displayed over the image of the shared document data.

As described above, an image of document data is shared among the respective terminal apparatuses 1, 1, . . . , and an image created by the terminal apparatus 1 itself is displayed over this image. Accordingly, the conference participants who use the respective terminal apparatuses 1, 1, . . . can browse the same document data, and can write notes made by themselves. In this case, the sound data collected by the microphone 117 in each of the terminal apparatuses 1, 1, . . . is also transmitted to the conference server apparatus 3, superimposed by the conference server apparatus 3, transmitted to the respective terminal apparatuses 1, 1, . . . , and outputted from the speaker 118 in each of the terminal apparatuses 1, 1, . . . . Thus, the electronic conference in which materials and sounds are shared can be implemented.

In this embodiment, consideration is given to a case where the conference participant who uses the A terminal apparatus 1 is a minutes recorder of the conference and a note is made on a statement of a speaker at the conference by using the tablet 113, the keyboard 112, etc. When a note is written by handwriting using the tablet 113 and the pen 130, the writing cannot keep up with the talking speed of a speaker in some cases. The minutes recorder is devotedly occupied with a note writing operation, which increases his or her burden.

Therefore, in Embodiment 1, the description will be made on the configuration of the conference system for aiding the conference participants to make useful notes that allow visual grasping of the relation between notes on statements and images with the use of the terminal apparatuses 1, 1, . . . by processing performed mainly by the control section 100, the temporary storage section 101, the storage section 102, the input processing section 103, the display processing section 104, the communication processing section 105, the input sound processing section 107, the sound recognition processing section 171 and the morphological analysis section 172 of each of the terminal apparatuses 1, 1, . . . .

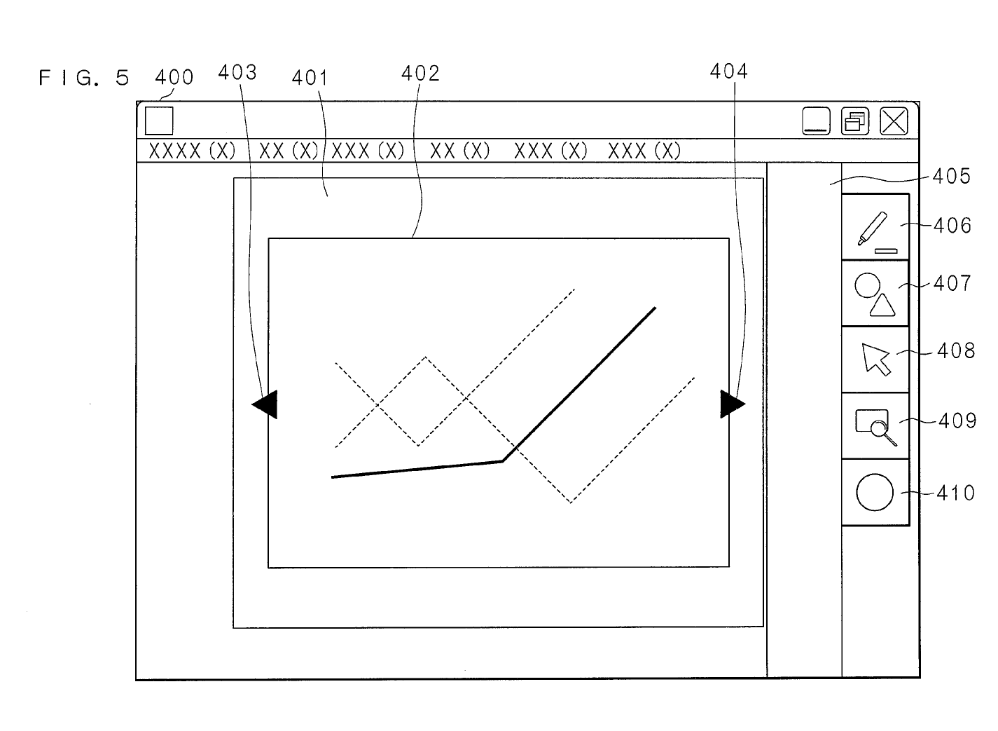

Upon start up of the conference terminal application by the conference participant in the above-described manner, the control section 100 of the terminal apparatus 1 loads the conference terminal program 1P, stored in the storage section 102, to execute the loaded conference terminal program 1P, and then the input screen is first displayed. When the conference participant is authenticated in response to authentication information inputted to the input screen, the control section 100 displays a main screen 400, thereby allowing the conference participant to start utilizing the terminal apparatus 1 as the conference terminal. FIG. 5 is an explanatory diagram illustrating an example of the main screen 400 of the conference terminal application, displayed on the display 114 of the terminal apparatus 1 used by the conference participant.

By way of example, the main screen 400 of the conference terminal application includes, throughout most of the screen, a shared screen 401 that displays an image of document data to be shared. In the example illustrated in FIG. 5, a document image 402 of the shared document data is entirely displayed on the shared screen 401.

At a left end position of an approximate center of the shared screen 401 in its height direction, a preceding page button 403 for providing an instruction for movement to the preceding page of the document data is displayed. Similarly, at a right end position of the approximate center of the shared screen 401 in its height direction, a next page button 404 for providing an instruction for movement to the next page (subsequent page) of the document data is displayed.

When the conference participant who uses the terminal apparatus 1 has performed a click operation while superimposing a pointer of the display 114 over the preceding page button 403 or the next page button 404 using the pen 130 or mouse, for example, an image of the preceding page or next page of the displayed document data is displayed on the shared screen 401.

At the right side of the shared screen 401, the main screen 400 includes a character string selection screen 405 that displays extracted ones of the character strings obtained as a result of processing performed by the sound recognition processing section 171 and analysis performed by the morphological analysis section 172 as will be described later. The character string selection screen 405 receives individual selection of a character string to be displayed. The selected character string can be copied and displayed at any position on the shared screen 401. Specifically, when the conference participant performs clicking while superimposing the pointer over a desired one of the character strings displayed on the character string selection screen 405, a copy of the character string is created, and when a dragging operation is performed with a click button of the mouse or the pen 130 kept pressed, the selected character string is displayed in accordance with the position of the pointer. When the click button is released, the character string is dropped and displayed at the position of the pointer at this point in time.

Furthermore, at a right end of the main screen 400, various operation buttons for selecting tools during drawing are displayed. The various operation buttons include: a pen button 406; a graphic button 407; a selection button 408; a zoom button 409; and a synchronous/asynchronous button 410.

The pen button 406 serves as a button for receiving free-line drawing performed using the pen. The pen button 406 also enables selection of color and thickness of the pen (line). With the pen button 406 selected, the conference participant clicks and drags the pen 130 or mouse, for example, on the shared screen 401, and is thus allowed to handwrite a note freely thereon.

The graphic button 407 is a button for receiving a selection of an image to be created. The graphic button 407 receives a selection of the type of an image created by the control section 100. For example, the graphic button 407 receives a selection of a graphic such as a circle, an ellipse or a polygon.

The selection button 408 is a button for receiving an operation other than drawing performed by the conference participant. For example, when the selection button 408 is selected, the control section 100 can receive, via the input processing section 103, a selection of a character string displayed on the character string selection screen 405, a selection of a character string already placed on the shared screen 401, a selection of a handwritten character that has already been drawn, a selection of an image that has already been created, etc. When a character string already placed on the shared screen 401 is selected, a menu button for receiving a change in format of this character string may be displayed.

The zoom button 409 is a button for receiving an enlargement/reduction operation for the image of the document data displayed on the shared screen 401. With the enlargement operation selected, the conference participant clicks the mouse or the pen 130 while superimposing the pointer over the shared screen 401, and then the image of the shared document data and a note written on this image are both displayed in an enlarged manner. A similar process is performed also when the reduction operation is selected.

The synchronous/asynchronous button 410 is a button for receiving a selection on whether or not synchronization is performed so that the displayed image of the document data displayed on the shared screen 401 becomes the same as that of the document data displayed on the particular one of the terminal apparatuses 1, 1, . . . . With synchronization selected, the page of the document data, displayed on the other terminal apparatuses 1, 1, . . . based on the browsed information on the particular terminal apparatus 1, is controlled by the control section 100 based on an instruction provided from the conference server apparatus 3 without reception of an operation for the preceding page, the next page or the like, performed by the conference participant who uses the terminal apparatus 1.

Upon reception of the foregoing operations performed using the various buttons included in the main screen 400, the control section 100 displays, on the shared screen 401, the image of the shared document data 36 received from the conference server apparatus 3, and receives drawing of a note performed in accordance with the operations.

In this case, each terminal apparatus 1 converts sounds, collected by the microphone 117, into sound data by the input sound processing section 107, performs sound recognition processing on the converted sound data by the sound recognition processing section 171, performs analysis on the converted sound data by the morphological analysis section 172, and extracts, from obtained character strings, a character string that satisfies a condition set in advance. Then, the terminal apparatus 1 transmits the extracted character string to the conference server apparatus 3 via the communication processing section 105.

The conference server apparatus 3 recognizes the received character string as the character string converted from a statement made during the conference, and transmits the character string to the respective terminal apparatuses 1, 1, . . . used by the conference participants.

Upon reception of the character string transmitted from the conference server apparatus 3, the control section 100 of each of the terminal apparatuses 1, 1, . . . displays the character string selection screen 405 to enable selection. Thus, sounds uttered by speakers are converted into character strings, the character strings are transmitted to the respective terminal apparatuses 1, 1, . . . used by the conference participants, and the character strings are displayed on the time series on the character string selection screen 405 of the main screen 400, thereby allowing the conference participants who take notes to select any desired character string when using the notes.

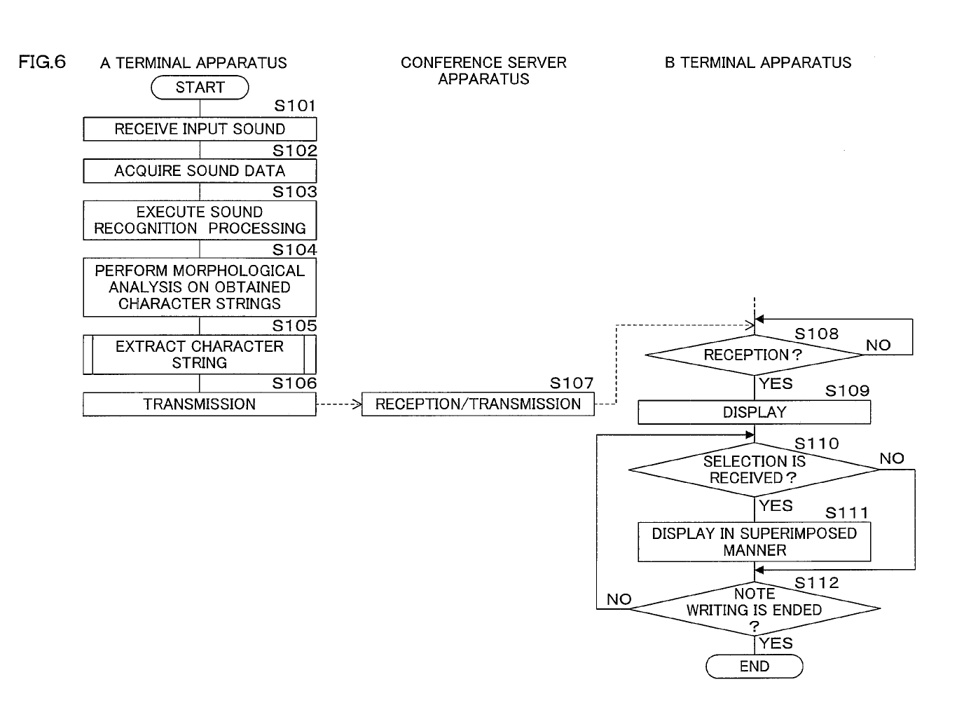

Details of processing performed by the respective terminal apparatuses 1, 1, . . . will be described with reference to a flow chart. First, an example of processing performed when a sound is inputted will be described. FIG. 6 is a flow chart illustrating an example of a procedure of processing performed by the terminal apparatuses 1, 1, . . . and conference server apparatus 3 included in the conference system according to Embodiment 1.

In the A terminal apparatus 1 to which sounds uttered by a speaker are inputted, the control section 100 receives input sounds via the microphone 117 (Step S101), and acquires the received input sounds as sound data by the input sound processing section 107 (Step S102). The control section 100 executes processing on the acquired sound data by the sound recognition processing section 171, thereby obtaining character strings (Step S103). The control section 100 supplies the obtained character strings to the morphological analysis section 172 to perform morphological analysis on the character strings (Step S104), extracts, from the character strings obtained as a result of the analysis, a character string that satisfies a condition set in advance (Step S105), and transmits the extracted character string to the conference server apparatus 3 (Step S106). The extraction process in Step S105 will be described in detail later.

Upon reception of the extracted character string from the A terminal apparatus 1, the conference server apparatus 3 transmits the received character string to the other terminal apparatuses 1, 1, . . . including the B terminal apparatus 1 (Step S107).

In the B terminal apparatus 1, the control section 100 determines whether or not the extracted character string is received by the communication processing section 105 (Step S108), and when it is determined that the extracted character string is not received (S108: NO), the control section 100 returns the procedure to Step S108 to enter a standby state until the character string is received. When it is determined that the extracted character string is received (S108: YES), the control section 100 displays the received character string on the character string selection screen 405 of the main screen 400 by the display processing section 104 (Step S109).

The control section 100 determines whether or not a selection of any one of the character strings displayed on the character string selection screen 405 is received in response to a notification provided from the input processing section 103 and indicative of clicking or the like performed on the character string selection screen 405 (Step S110). When it is determined that the selection of the character string is received (S110: YES), the control section 100 displays the selected character string in a superimposed manner at any position on the image of the shared document data in response to a notification from the input processing section 103 and in accordance with an operation as mentioned above (Step S111). When it is determined that the selection of the character string is not received (S110: NO), the control section 100 moves the procedure to Step S112.

The control section 100 determines whether or not note writing is ended, for example, by selection of a menu or the like which provides an instruction to end note writing (Step S112). When it is determined that note writing is not ended (S112: NO), the control section 100 returns the procedure to Step S110 to determine, for example, whether or not the selection of the other character string or the like is received. When it is determined in Step S112 that note writing is ended (S112: YES), the control section 100 ends the procedure for aiding note writing.

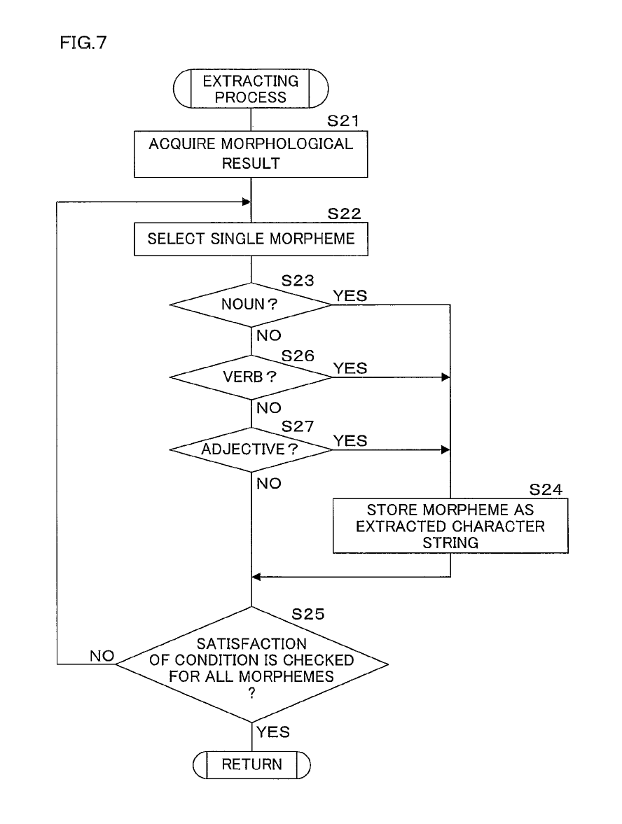

FIG. 7 is a flow chart illustrating processing for extracting a character string, which satisfies a condition, from character strings obtained by morphological analysis executed by the control section 100 of the terminal apparatus 1 included in the conference system according to Embodiment 1. A processing procedure illustrated in the flow chart of FIG. 7 is associated with the details of Step S105 included in the processing procedure of FIG. 6.

In the terminal apparatus 1 used by the speaker, the control section 100 acquires a result obtained by analysis performed by the morphological analysis section 172 (Step S21). For example, when the character string obtained by the sound recognition processing section 171 is “the value is very important.”, the control section 100 can acquire, via the morphological analysis section 172, the following character string: “the (article)/value (noun)/is (verb)/very (adverb)/important (adjective)/. (period)”.

The control section 100 selects a single morpheme from the morphological analysis result (Step S22), and determines in Steps S23, S26 and S27 whether or not the selected morpheme satisfies a condition set in advance. Specifically, the condition set in advance in the processing described with reference to the flow chart of FIG. 7 requires that noun, verb and adjective morphemes be determined as an extracted character string.

First, the control section 100 determines whether or not the part of speech of the selected morpheme is a noun (Step S23). When it is determined that the selected morpheme is a noun (S23: YES), the control section 100 stores the morpheme as an extracted character string (Step S24). The control section 100 determines whether or not the satisfaction of the condition is checked for all morphemes (Step S25). When it is determined that the satisfaction of the condition is not checked for all morphemes (S25: NO), the control section 100 returns the procedure to Step S22 to perform the processing on the next morpheme.

When it is determined that the selected morpheme is not a noun (S23: NO), the control section 100 determines whether or not the selected morpheme is a verb (Step S26). When it is determined that the selected morpheme is a verb (S26: YES), the control section 100 stores the selected morpheme as an extracted character string since the selected morpheme satisfies the condition (Step S24), and moves the procedure to Step S25.

When it is determined that the selected morpheme is not a verb (S26: NO), the control section 100 determines whether or not the selected morpheme is an adjective (Step S27). When it is determined that the selected morpheme is an adjective (S27: YES), the control section 100 stores the selected morpheme as an extracted character string since the selected morpheme satisfies the condition (Step S24), and moves the procedure to Step S25.

When it is determined that the selected morpheme is not an adjective (S27: NO), the control section 100 moves the procedure to Step S25.

When it is determined in Step S25 that the satisfaction of the condition is determined for all morphemes (S25: YES), the control section 100 ends the extraction processing, and returns the procedure to Step S106 included in the processing procedure illustrated in the flow chart of FIG. 6.

When “the (article)/value (noun)/is (verb)/very (adverb)/important (adjective)/. (period)” is acquired in Step S21, “value (noun)”, “is (verb)” and “important (adjective)” are stored as the extracted character string due to the determinations made in Steps S23, S26 and S27.

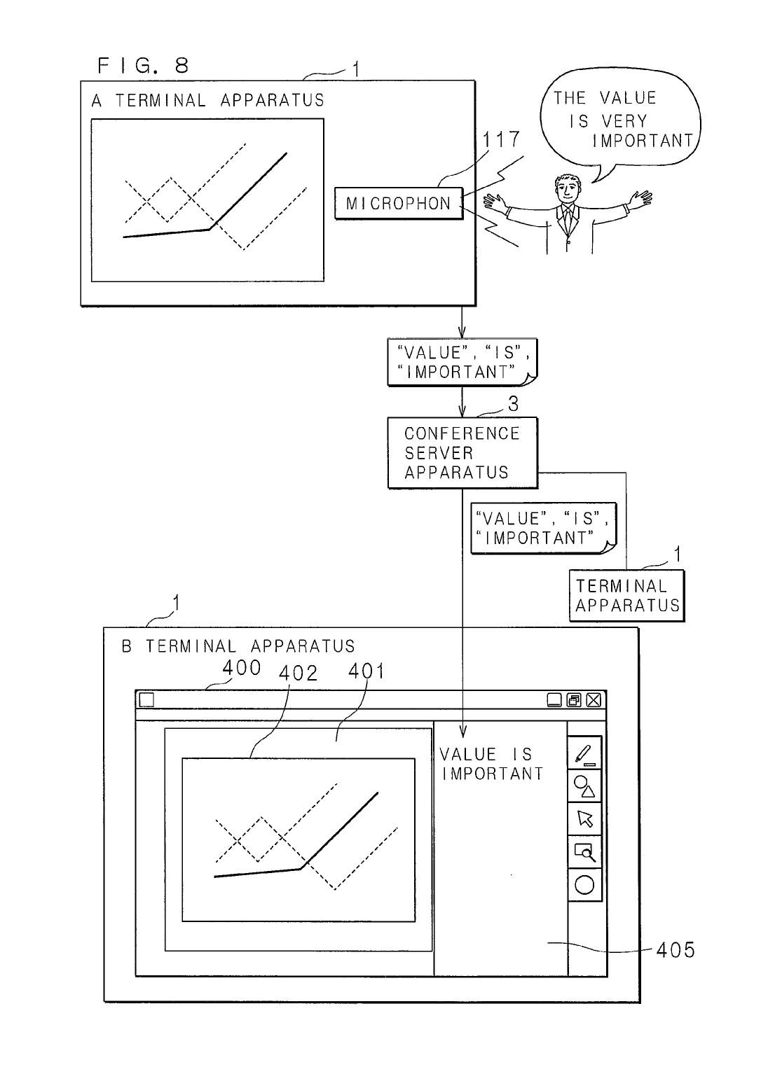

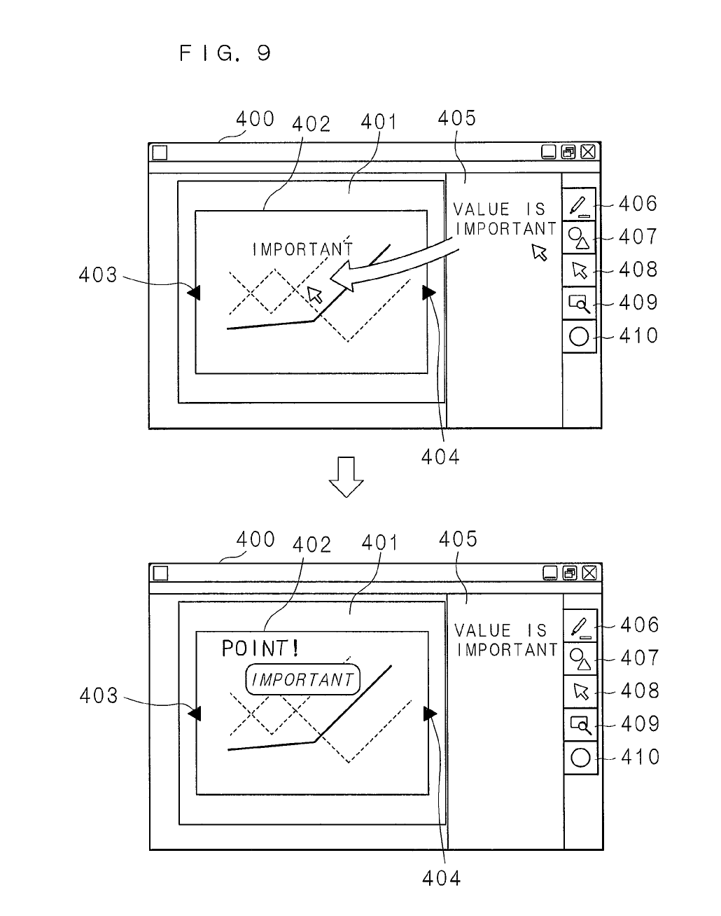

FIGS. 8 and 9 are explanatory diagrams schematically illustrating specific examples of the processing procedure illustrated in FIGS. 6 and 7. FIG. 8 illustrates an example in which a received character string is displayed on the character string selection screen 405, and FIG. 9 illustrates an example in which a character string is selected from the character string selection screen 405 and is displayed on an image of shared document data in a superimposed manner. In either case, the image of the shared document data is displayed on the main screen 400.

As illustrated in FIG. 8, upon acquisition of sound data of a speaker by the microphone 117 of the A terminal apparatus 1, sound recognition processing, morphological analysis processing and extraction processing are performed as described above in the A terminal apparatus 1, and a character string of “value”, “is” and “important” is transmitted to the conference server apparatus 3.

The conference server apparatus 3 transmits this character string to the respective receiving terminal apparatuses 1, 1, . . . . The character string of “value”, “is” and “important” is transmitted also to the B terminal apparatus 1 used by the conference participant who takes a note.

As illustrated in FIG. 8, the B terminal apparatus 1 receives the character string of “value”, “is” and “important” by processing preformed by the control section 100, and the control section 100 displays the received character string on the character string selection screen 405 of the main screen 400. Thus, the conference participant who takes a note can make a note just by selecting the displayed character string without taking a note on the character string including “value”, “is” and “important” using the pen 130 or the keyboard 112 by himself or herself.

Further, as illustrated in FIG. 9, when the character string is selected on the character string selection screen 405, the character string can be displayed in a superimposed manner over the shared document data image 402 on the shared screen 401, thus making it possible to make a note that indicates the location of “value” using its position on the shared document data image 402.

Besides, as illustrated in a lower part of FIG. 9, format change can be selected with the selected character string “important” displayed on the shared document data image 402, thereby making it possible to change the format to italic, and to add a box as illustrated in FIG. 9. Moreover, since the pen button 406 may be selected to write a note, a note such as “POINT!” may also be written as illustrated in FIG. 9.

As described above, sound data related to shared document data to be displayed is converted into a character string to display the character string on the terminal apparatuses 1, 1, . . . used by the conference participants, and the character string is displayed in a selectable manner so as to be placed on an image of the shared document data. Accordingly, it is possible to reduce an operational burden on the conference participant who makes a note, and in addition, it is possible to aid the conference participant to make a useful note that allows visual grasping of sound contents related to the shared document together with the image. A note can be placed by optionally selecting its position on the image, thus making it possible to make a useful note that allows visual grasping of the relation between the character string and each portion of the image.

Note that the character string extraction condition illustrated in FIG. 7 may be set freely in advance. For example, a condition that requires only a noun to be extracted may be set, thereby enabling extraction of a character string that reflects the intent of the conference participant. Thus, an efficient and effective note can be made without burden. Besides, since character strings can be narrowed down by reflecting the intent of the conference participant so that only a character string including a particular word is extracted, a note making operation can be performed without burden by reflecting his or her intent.

Furthermore, editing including format change of a selected character is enabled, and a note written by the conference participant himself or herself can also be freely placed on an image of shared document data in a mixed manner; therefore, false recognition in sound recognition, false conversion into a Chinese character, etc. may also be corrected. An operation for making an effective note, including addition such as highlighted display that uses a box or an underline, for example, is also enabled, thereby making it possible to effectively aid note making at a conference.

### Embodiment 2

In Embodiment 1, the terminal apparatuses 1, 1, . . . are each configured to include the sound recognition processing section 171 and the morphological analysis section 172. On the other hand, in Embodiment 2, a server apparatus is configured to include a sound recognition processing section and a morphological analysis section.

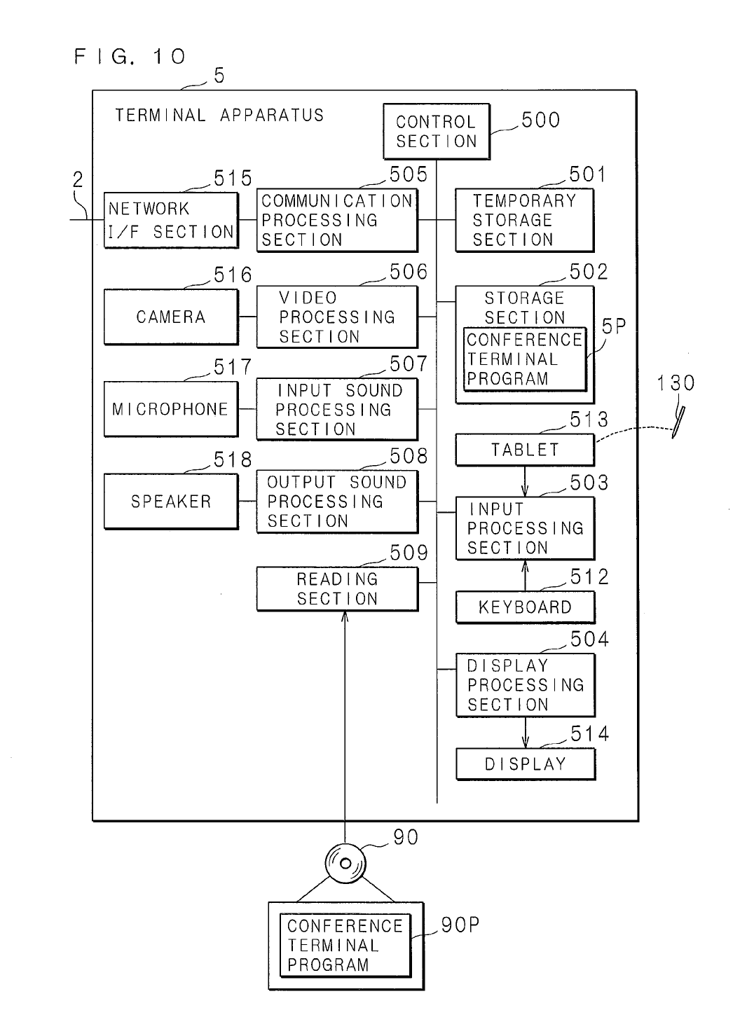

FIG. 10 is a block diagram illustrating an internal configuration of a terminal apparatus 5 included in a conference system according to Embodiment 2.

For the terminal apparatus 5, a personal computer equipped with a touch panel or a terminal intended exclusively for use in the conference system is used similarly to the terminal apparatus 1 according to Embodiment 1. The terminal apparatus 5 includes: a control section 500; a temporary storage section 501; a storage section 502; an input processing section 503; a display processing section 504; a communication processing section 505; a video processing section 506; an input sound processing section 507; an output sound processing section 508; and a reading section 509. Moreover, the terminal apparatus 5 further includes a keyboard 512, a tablet 513, a display 514, a network I/F section 515, a camera 516, a microphone 517, and a speaker 518, which may be contained in the terminal apparatus 5 or may be externally connected to the terminal apparatus 5.

The foregoing constituent elements of the terminal apparatus 5 according to Embodiment 2 are similar to those of the terminal apparatus 1 according to Embodiment 1, and are identified by corresponding reference characters, thereby omitting detailed description thereof. In other words, the terminal apparatus 5 according to Embodiment 2 does not include the constituent elements corresponding to the sound recognition processing section 171 and the morphological analysis section 172. Basically, the terminal apparatus 5 performs processing similar to that performed by the terminal apparatus 1 according to Embodiment 1, except processing concerning the sound recognition processing section 171 and the morphological analysis section 172.

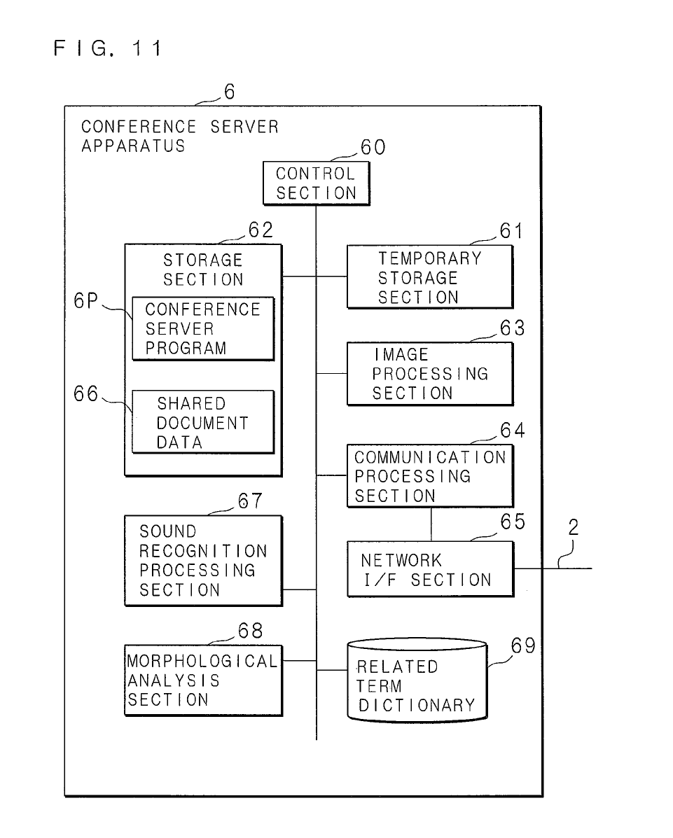

FIG. 11 is a block diagram illustrating an internal configuration of a conference server apparatus 6 included in the conference system according to Embodiment 2.

For the conference server apparatus 6, a server computer is used. The conference server apparatus 6 includes: a control section 60; a temporary storage section 61; a storage section 62; an image processing section 63; a communication processing section 64; a sound recognition processing section 67; a morphological analysis section 68; and a related term dictionary 69, and further contains a network I/F section 65.

The control section 60, temporary storage section 61, storage section 62, image processing section 63 and communication processing section 64 are similar to the control section 30, temporary storage section 31, storage section 32, image processing section 33 and communication processing section 34 which are the constituent elements of the conference server apparatus 3 according to Embodiment 1, and therefore, detailed description thereof will be omitted. Also in the storage section 62, a conference server program 6P and shared document data 66 are stored similarly to the conference server apparatus 3 according to Embodiment 1.

The sound recognition processing section 67 includes a dictionary that defines the correspondence between sounds and character strings, and performs, upon supply of sound data, sound recognition processing for converting the sound data into a character string to output the resulting character string. The control section 60 supplies sound data, obtained by the communication processing section 64, to the sound recognition processing section 67 in predetermined units, and acquires the character string outputted from the sound recognition processing section 67. The sound recognition processing section 67 performs processing similar to that performed by the sound recognition processing section 171 included in the terminal apparatus 1 according to Embodiment 1.

The morphological analysis section 68 performs morphological analysis when a character string is supplied thereto, divides the supplied character string into morphemes to output the morphemes, and outputs information or the like indicative of how many morphemes are included in the character string and the part of speech of each morpheme. The morphological analysis section 68 performs processing similar to that performed by the morphological analysis section 172 included in the terminal apparatus 1 according to Embodiment 1.

Upon supply of a character string in units of morphemes, the related term dictionary 69 outputs a single or a plurality of related terms. Note that a character string supplied in this case includes a noun, a verb or an adjective.

Also in the conference system according to Embodiment 2 configured as described above, an electronic conference is implemented by processes similar to those performed in Embodiment 1. The shared document data 66 stored in the storage section 62 of the server apparatus 6 is converted into images by the image processing section 63, and the images are transmitted to the respective terminal apparatuses 5, 5, . . . by the communication processing section 64. The terminal apparatuses 5, 5, . . . receive these images to display the images of the shared document data, thereby implementing the electronic conference in which materials are shared.

Embodiment 2 is similar to Embodiment 1 in that notes can be written on the images of the shared document data on the respective terminal apparatuses 5, 5, . . . . A character string converted from sounds uttered by a speaker is displayed on the character string selection screen 405 of the main screen 400, and a conference participant can make a note by selecting the character string.

As described above, Embodiment 2 differs from Embodiment 1 in that the sound recognition processing section 67 and the morphological analysis section 68 are provided in the conference server apparatus 6 and the conference server apparatus 6 includes the related term dictionary 69. Accordingly, a processing procedure of Embodiment 2, including steps different from those of Embodiment 1 due to the foregoing differences, will be described below.

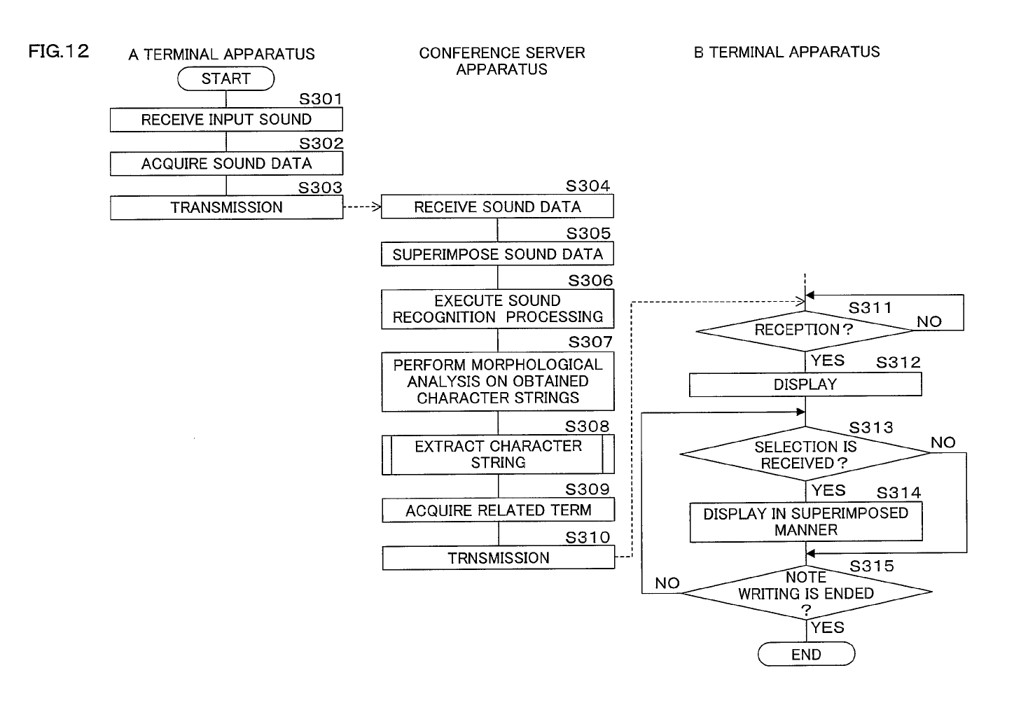

FIG. 12 is a flow chart illustrating an example of a procedure of processing performed by the terminal apparatuses 5, 5, . . . and the conference server apparatus 6 included in the conference system according to Embodiment 2.

In each of the terminal apparatuses 5, 5, . . . , the control section 500 receives input sounds via the microphone 517 (Step S301), and acquires the received input sounds as sound data by the input sound processing section 507 (Step S302). The control section 500 of each of the terminal apparatuses 5, 5, . . . transmits the acquired sound data to the conference server apparatus 6 by the communication processing section 505 (Step S303).

The control section 60 of the conference server apparatus 6 receives the sound data transmitted from the respective terminal apparatuses 5, 5, . . . (Step S304), and superimposes the sound data received from the respective terminal apparatuses 5, 5, . . . to provide a single piece of sound data (Step S305). These steps are performed in order to convert sounds of the overall conference into character strings. The control section 60 executes, by the sound recognition processing section 67, sound recognition processing on the sound data obtained by the superimposition process (Step S306), and performs, by the morphological analysis section 68, analysis on character strings obtained from the sound recognition processing section 67 (Step S307). Then, the control section 60 extracts, from the character strings obtained as a result of the analysis, a character string that satisfies a condition set in advance (Step S308). The control section 60 supplies the extracted character string to the related term dictionary 69 to acquire a related term (Step S309), and transmits the extracted character string and the related term to the respective terminal apparatuses 5, 5, . . . (Step S310). Note that details of Step S308 are similar to those of the processing procedure illustrated in the flow chart of FIG. 7, and therefore, detailed description thereof will be omitted.

In each of the terminal apparatuses 5, 5, . . . , the control section 500 determines whether or not the extracted character string is received by the communication processing section 505 (Step S311), and when it is determined that the extracted character string is not received (S311: NO), the control section 500 returns the procedure to Step S311 to enter a standby state until the character string is received. When it is determined that the extracted character string is received (S311: YES), the control section 500 displays the received character string on the character string selection screen 405 of the main screen 400 by the display processing section 504 (Step S312).

The control section 500 determines whether or not a selection of any one of the character strings displayed on the character string selection screen 405 is received in response to a notification provided from the input processing section 503 and indicative of clicking or the like performed on the character string selection screen 405 (Step S313). When it is determined that the selection of the character string is received (S313: YES), the control section 500 displays the selected character string in a superimposed manner at any position on the image of the shared document data in response to a notification from the input processing section 503 and in accordance with an operation as mentioned above (Step S314). When it is determined that the selection of the character string is not received (S313: NO), the control section 500 moves the procedure to Step S315.

The control section 500 determines whether or not note writing is ended, for example, by selection of a menu or the like which provides an instruction to end note writing (Step S315). When it is determined that note writing is not ended (S315: NO), the control section 500 returns the procedure to Step S313 to determine, for example, whether or not the selection of the other character string or the like is received. When it is determined in Step S315 that note writing is ended (S315: YES), the control section 500 ends the procedure for aiding note writing.

Even when sound recognition processing and morphological analysis processing are not performed in the respective terminal apparatuses 1, 1, . . . but performed in the conference server apparatus 6 as described above, effects similar to those of Embodiment 1 are achieved. When sound recognition processing and morphological analysis processing are performed in the conference server apparatus, sounds provided from the respective terminal apparatuses 5, 5, . . . may also be collectively recognized.

The conference server apparatus 6 is configured to include the related term dictionary 69 to enable extraction of a related term and transmission of the extracted related term to the respective terminal apparatuses 5, 5, . . . as in Embodiment 2. Thus, thus, a related term other than terms included in sound data that is a source of conversion for a character string can also be utilized for a note, and a user is allowed to perform a note making operation without burden by flexibly reflecting his or her intent.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An information processing apparatus for receiving image information via communication means, and for displaying, on a display section, an image provided based on the received image information, the information processing apparatus comprising:
a conversion section for acquiring sound data related to the image information, and for converting the sound data into a character string;
an analysis section for performing morphological analysis on the converted character string;
a first extraction section for extracting a character string that satisfies a condition set in advance, the character string being extracted from character strings each including a single or a plurality of morphemes obtained as a result of the analysis performed by the analysis section;
a first display control section for displaying, on the display section, the character string extracted by the first extraction section;
a first reception section for receiving selection of any one or a plurality of character strings included in the displayed character strings; and
a second display control section for displaying the selected character string in a superimposed manner at any position on the image provided based on the image information.

2. The information processing apparatus according to claim 1,
the information processing apparatus further comprising a second reception section for receiving a change in the position of the selected character string, received by the first reception section, on the image provided based on the image information.

3. The information processing apparatus according to claim 1,
the information processing apparatus further comprising a third reception section for receiving an edit made on the selected character string received by the first reception section.

4. The information processing apparatus according to claim 1,
the information processing apparatus further comprising a fourth reception section for receiving a change in format of the selected character string received by the first reception section.

5. The information processing apparatus according to claim 1,
the information processing apparatus further comprising:
a first storage section for storing an optional plurality of terms in advance;
a second extraction section for extracting, from the plurality of terms, a term related to the character string displayed on the display section; and
a third display control section for displaying the extracted term on the display section.

6. The information processing apparatus according to claim 1,
wherein the condition set in advance is set using a type of part of speech or a combination of types of parts of speech.

7. The information processing apparatus according to claim 1,
the information processing apparatus further comprising:
a fifth reception section for receiving input of an optional character string or image;
a sixth reception section for receiving a change in the position of the inputted character string or image; and
a fourth display control section for displaying, based on the position, the inputted character string or image.

8. An information processing apparatus for receiving image information via communication means, and for displaying, on a display section, an image provided based on the received image information, the information processing apparatus comprising:
a fifth display control section for receiving a plurality of character strings provided based on sound data related to the image information, and for displaying a plurality of the received character strings on the display section;
a seventh reception section for receiving selection of any one or a plurality of character strings included in a plurality of the displayed character strings; and
a sixth display control section for displaying the selected character string in a superimposed manner at any position on the image provided based on the image information.

9. The information processing apparatus according to claim 8,
the information processing apparatus further comprising an eighth reception section for receiving a change in the position of the selected character string, received by the seventh reception section, on the image provided based on the image information.

10. The information processing apparatus according to claim 8,
the information processing apparatus further comprising a ninth reception section for receiving an edit made on the selected character string received by the seventh reception section.

11. The information processing apparatus according to claim 8,
the information processing apparatus further comprising a tenth reception section for receiving a change in format of the selected character string received by the seventh reception section.

12. The information processing apparatus according to claim 8,
the information processing apparatus further comprising:
a second storage section for storing an optional plurality of terms in advance;
a third extraction section for extracting, from the plurality of terms, a term related to the character string displayed on the display section; and
a seventh display control section for displaying the extracted term on the display section.

13. The information processing apparatus according to claim 8,
the information processing apparatus further comprising:
an eleventh reception section for receiving input of an optional character string or image;
a twelfth reception section for receiving a change in the position of the inputted character string or image; and
an eighth display control section for displaying, based on the position, the inputted character string or image.

14. A conference system comprising:
a server apparatus for storing image information; and
a plurality of information processing apparatuses each capable of communicating with the server apparatus and comprising a display section,
wherein the plurality of information processing apparatuses each receive the image information from the server apparatus to display, on the display section, an image provided based on the received image information, and allow a common image to be displayed on the plurality of information processing apparatuses so that information is shared among the plurality of information processing apparatuses, thereby implementing a conference,
wherein the server apparatus or at least one of the plurality of information processing apparatuses comprises:
an input section for inputting of a sound; and
a conversion section for converting the sound, inputted by the input section, into a character string,
wherein the server apparatus or any of the plurality of information processing apparatuses comprises:
an analysis section for performing morphological analysis on the character string that has been converted by the conversion section;
an extraction section for extracting a character string that satisfies a condition set in advance, the character string being extracted from character strings each including a single or a plurality of morphemes obtained as a result of the analysis performed by the analysis section; and
a first transmission section for transmitting, to the server apparatus, the character string extracted by the extraction section,
wherein the server apparatus comprises a second transmission section for transmitting, to any one or a plurality of the information processing apparatuses, the character string extracted by the extraction section, and
wherein the information processing apparatus comprises:
a first display control section for displaying, on the display section, the character string received from the server apparatus;
a reception section for receiving selection of any one or a plurality of character strings included in the displayed character strings; and
a second display control section for displaying the selected character string in a superimposed manner at any position on the image provided based on the image information.

15. An information processing method for using an information processing apparatus, comprising communication means and a display section, to display, on the display section, an image provided based on received image information,
the information processing method comprising steps of:
acquiring sound data related to the image information and converting the sound data into a character string;
performing morphological analysis on the converted character string;
extracting a character string that satisfies a condition set in advance, the character string being extracted from character strings each including a single or a plurality of morphemes obtained as a result of the analysis;
displaying the extracted character string on the display section;
receiving selection of any one or a plurality of character strings included in the displayed character strings; and
displaying the selected character string in a superimposed manner at any position on the image provided based on the image information.

16. An information processing method for using a system comprising: a server apparatus for storing image information; and a plurality of information processing apparatuses each capable of communicating with the server apparatus and comprising a display section, in which the plurality of information processing apparatuses each receive the image information from the server apparatus to display, on the display section, an image provided based on the received image information, and allow a common image to be displayed on the plurality of information processing apparatuses so that information is shared among the plurality of information processing apparatuses,
the information processing method comprising steps of:
allowing at least one apparatus of the server apparatus and the plurality of information processing apparatuses to input a sound associated with an image that is being displayed;
allowing at least one apparatus of the server apparatus and the plurality of information processing apparatuses to convert the inputted sound into a character string;
allowing the server apparatus or any of the plurality of information processing apparatuses to perform morphological analysis on the character string that has been converted by the at least one apparatus;
allowing the server apparatus or any of the plurality of information processing apparatuses to extract a character string that satisfies a condition set in advance, the character string being extracted from character strings each including a single or a plurality of morphemes obtained as a result of the morphological analysis;
allowing the server apparatus or any of the plurality of information processing apparatuses to transmit the extracted character string to the server apparatus, or to store the extracted character string in the server apparatus or information processing apparatus itself;
allowing the server apparatus to transmit the extracted character string to any one or a plurality of the information processing apparatuses;
allowing the information processing apparatus, which has received the extracted character string, to display the received character string on the display section;
allowing the information processing apparatus, which has received the extracted character string, to receive selection of any one or a plurality of character strings included in the displayed character strings; and
allowing the information processing apparatus, which has received the extracted character string, to display the selected character string in a superimposed manner at any position on the image provided based on the image information.

17. A recording medium recording a computer program for allowing a computer, comprising communication means and means for connecting with a display section, to display, on the display section, an image provided based on received image information, said computer program comprising steps of;
causing the computer to acquire sound data related to the image information, and to convert the sound data into a character string;
causing the computer to perform morphological analysis on the converted character string;
causing the computer to extract a character string that satisfies a condition set in advance, the character string being extracted from character strings each including a single or a plurality of morphemes obtained as a result of the morphological analysis;
causing the computer to display the extracted character string on the display section;
causing the computer to receive selection of any one or a plurality of character strings included in the displayed character strings; and
causing the computer to display the selected character string in a superimposed manner at any position on the image provided based on the image information.
